(19) United States
(12) Patent Application Publication
(10) Pub. No.: US 2016/0330414 A1
(43) Pub. Date: Nov. 10, 2016

(54) IMAGING APPARATUS, IMAGING SYSTEM, AND SIGNAL PROCESSING METHOD

(71) Applicant: CANON KABUSHIKI KAISHA, Tokyo (JP)

(72) Inventors: Hisashi Takado, Kawasaki-shi (JP); Noriyuki Kaifu, Atsugi-shi (JP); Fujio Kawano, Kawasaki-shi (JP); Tomoya Onishi, Ayase-shi (JP)

(21) Appl. No.: 15/143,724

(22) Filed: May 2, 2016

(30) Foreign Application Priority Data
May 8, 2015 (JP) 2015-095406

(51) Int. Cl. H04N 9/04; H04N 1/60; H04N 5/225; H04N 9/67; H04N 5/357; H04N 5/235

(52) U.S. Cl. CPC H04N 9/045; H04N 5/357; H04N 5/2351; H04N 5/2256; H04N 9/67; H04N 1/6008

(57) ABSTRACT

Provided is an imaging apparatus including: a first signal processing unit configured to generate first data on a plurality of frames by executing processing for generating the first data by using first pixel signals in one frame, which have been output from a first pixel group, for the first pixel signal in each frame, the first data being obtained by interpolating a pixel signal corresponding to a first wavelength band in a second pixel group; a second signal processing unit configured to generate second data on a plurality of frames by using second pixel signals in the plurality of frames, which have been output from the second pixel group; and a signal combining unit configured to generate an image by combining the first data on the plurality of frames and the second data on the plurality of frames.

### BACKGROUND OF THE INVENTION

1. Field of the Invention

The present invention relates to an imaging apparatus, an imaging system, and a signal processing method.

2. Description of the Related Art

In a solid-state imaging device of a single-plate type, in order to obtain a color image, color filters (CFs) each configured to transmit light of a specific wavelength component, for example, light of a color of red (R), green (G), or blue (B), are arrayed on pixels in a predetermined pattern. As a pattern of CFs, a pattern having a so-called Bayer array is used. In the following, a pixel in which the CF of R is arranged is referred to as “R pixel”, a pixel in which the CF of G is arranged is referred to as “G pixel”, a pixel in which the CF of B is arranged is referred to as “B pixel”, and a pixel in which no CF is arranged is referred to as “N pixel”. The N pixel is referred to also as “white pixel”. In addition, the R pixel, the G pixel, and the B pixel are sometimes referred to collectively as “RGB pixels” or “color pixels”.

A signal of any one of color components is output from each pixel of the solid-state imaging device of a single-plate type. Therefore, the output signal needs to be subjected to color interpolation processing to generate signals of all the color components. For example, in the Bayer array, when a spatial frequency of an object is high, a moire and a false color can occur as a result of conducting color interpolation processing. In Japanese Patent Application Laid-Open No. 2013-197613, there is disclosed a technology for preventing reduction of a sense of resolution in a moving image while suppressing the occurrence of a moire and a false color.

In an imaging apparatus disclosed in Japanese Patent Application Laid-Open No. 2013-197613, processing for spatially shifting the position of weighted addition for each color is conducted in order to alleviate influence of the false color due to the thinning of a moving image. However, in a CF array exhibiting a rough cycle of a spatial arrangement of RCB pixels, it is difficult to sufficiently suppress the false color. Further, when a moving image is acquired, movement of the object causes the spatial pattern of the false color to change over time. Therefore, the false color appears as a flicker, which causes reduction in image quality.

### SUMMARY OF THE INVENTION

According to one embodiment of the present invention, there is provided an imaging apparatus configured to conduct signal processing for a pixel signal received from an imaging device, the imaging device including: a first pixel group including a plurality of pixels each configured to output a first pixel signal based on light having a first wavelength band including at least a wavelength band corresponding to green; and a second pixel group including a plurality of pixels each configured to output a second pixel signal based on one of light having a wavelength band narrower than the first wavelength band and light having a wavelength band different from the first wavelength band, the imaging apparatus including: a first signal processing unit configured to generate first data on a plurality of frames by executing processing for generating the first data by using first pixel signals in one frame, which have been output from the first pixel group, for the first pixel signal in each frame, the first data being obtained by interpolating the pixel signal corresponding to the first wavelength band in the second pixel group; a second signal processing unit configured to generate second data on a plurality of frames by using second pixel signals in the plurality of frames, which have been output from the second pixel group; and a signal combining unit configured to generate an image by combining the first data on the plurality of frames and the second data on the plurality of frames.

According to another embodiment of the present invention, there is provided a signal processing method for conducting signal processing for a pixel signal received from an imaging device, the imaging device including: a first pixel group including a plurality of pixels each configured to output a first pixel signal based on light having a first wavelength band including at least a wavelength band corresponding to green; and a second pixel group including a plurality of pixels each configured to output a second pixel signal based on one of light having a wavelength band narrower than the first wavelength band and light having a wavelength band different from the first wavelength band, the signal processing method including: generating first data on a plurality of frames by executing processing for generating the first data by using first pixel signals in one frame, which have been output from the first pixel group, for the first pixel signal in each frame, the first data being obtained by interpolating the pixel signal corresponding to the first wavelength band in the second pixel group; generating second data on a plurality of frames by using second pixel signals in a plurality of frames, which have been output from the second pixel group; and generating an image by combining the first data on the plurality of frames and the second data on the plurality of frames.

Further features of the present invention will become apparent from the following description of exemplary embodiments with reference to the attached drawings.

### BRIEF DESCRIPTION OF THE DRAWINGS

FIG. 1 is a block diagram of an imaging apparatus according to a first embodiment of the present invention.

FIG. 2 is a block diagram of an imaging device according to the first embodiment.

FIG. 3 is a circuit diagram of the imaging device and a column amplifying unit according to the first embodiment.

FIGS. 4A, 4B, 4C and 4D are diagrams for illustrating examples of a color filter array using RGB.

FIGS. 5A, 5B, 5C and 5D are diagrams for illustrating examples of a color filter array using complementary colors.

FIG. 6 is a block diagram of a signal processing unit of the imaging apparatus according to the first embodiment.

FIGS. 7A and 7B are diagrams for illustrating examples of inter-frame processing according to the first embodiment.

FIGS. BA, 8B, 8C, 8D and BE are diagrams and a graph for illustrating and showing an action of the inter-frame processing according to the first embodiment.

FIG. 9 is a table for showing evaluation results of the imaging apparatus according to the first embodiment.

FIG. 10 is a block diagram of a signal processing unit of an imaging apparatus according to a second embodiment of the present invention.

FIG. 11 is a table for showing evaluation results of the imaging apparatus according to the second embodiment.

FIG. 12 is a block diagram of a signal processing unit of an imaging apparatus according to a third embodiment of the present invention.

FIG. 13 is a block diagram of a signal processing unit of an imaging apparatus according to a fourth embodiment of the present invention.

FIG. 14 is a block diagram of a signal processing unit of an imaging apparatus according to a fifth embodiment of the present invention.

FIG. 15 is a block diagram of a signal processing unit of an imaging apparatus according to a sixth embodiment of the present invention.

FIG. 16 is a block diagram of a signal processing unit of an imaging apparatus according to a seventh embodiment of the present invention.

FIG. 17 is a diagram for illustrating an example of a configuration of an imaging system according to an eighth embodiment of the present invention.

### DESCRIPTION OF THE EMBODIMENTS

Now, an imaging apparatus according to each embodiment of the present invention is described with reference to the accompanying drawings.

### First Embodiment

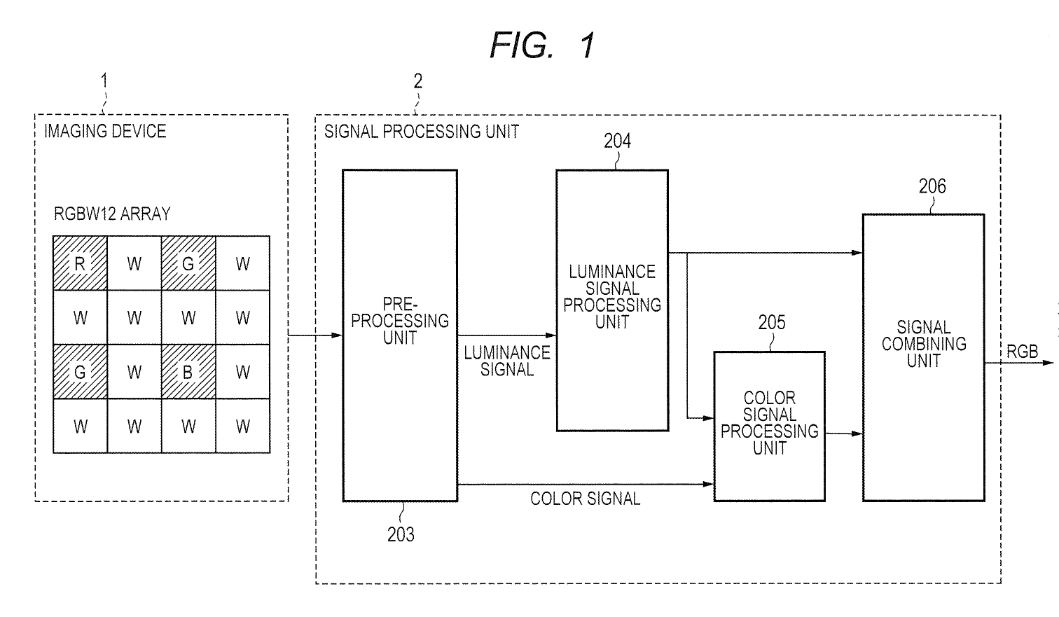

FIG. 1 is a block diagram of an imaging apparatus according to a first embodiment of the present invention. The imaging apparatus includes an imaging device 1 and a signal processing unit 2. The imaging device 1 is a so-called single-plate color sensor in which color filters are arranged on a CMOS image sensor or on a CCD image sensor. When a color image is formed with a single-plate color sensor, interpolation needs to be conducted as described later. For example, an R pixel has no information (pixel value) of G or B. Therefore, based on pixel values of G and B around the R pixel, pixel values of G and B in the R pixel are generated by interpolation processing. The imaging device 1 includes a plurality of pixels arrayed in a matrix shape, for example, includes 2,073,600 pixels in total of 1,920 pixels in a column direction and 1,080 pixels in a row direction. The number of pixels of the imaging device 1 is not limited thereto, and may be a larger number of pixels or a smaller number of pixels. The imaging device 1 and the signal processing unit 2 may be mounted on the same chip, or may be mounted on another chip or apparatus. In addition, the imaging apparatus may not necessarily include the imaging device 1, and it suffices that the imaging apparatus include the signal processing unit 2 configured to process a pixel signal (RAW data) received from the imaging device 1.

CFs according to this embodiment have an RGBW12 array illustrated in FIG. 1. In the RGBW12 array, a 4×4 pixel array is repeated, and a ratio of the numbers of pixels among the respective colors is R:G:B:W=1:2:1:12. In the RGBW12 array, the pixels of R, G, and B being color pixels are each surrounded by eight W pixels, and the proportion of the W pixels accounts for ¾ of all the pixels. In other words, the RGBW12 array includes W pixels as a first pixel group, and includes color pixels (RGB pixels) as a second pixel group. A total sum of the number of pixels of the first pixel group is three or more times larger (more than two times or larger) than a total sum of the number of pixels of the second pixel group, and the second pixel group has less resolution information than the first pixel group. Note that, the imaging device 1 can include not only effective pixels but also pixels that do not output an image, such as an optical black pixel and a dummy pixel that does not include a photoelectric converter. However, the optical black pixel or the dummy pixel is not included in the first pixel group or the second pixel group. The W pixel has a wider spectral sensitivity characteristic and a higher sensitivity than the RGB pixel. The W pixel outputs a first pixel signal based on light having a first wavelength band, which includes at least a wavelength band corresponding to green and further includes wavelength bands of red and blue. The RGB pixel outputs a second pixel signal based on light having a wavelength band narrower than the first wavelength band. The second pixel group includes the RGB pixels, and hence it should be understood that the second pixel group includes pixels having mutually different wavelength bands of light.

In the RGBW12 array, the W pixels are arranged around each of the RGB pixels, and hence a W pixel value in the position of the RGB pixel can be interpolated with high accuracy. The W pixels account for ¾ of all the pixels, and thus the sensitivity can be improved. This embodiment is particularly effective for the imaging device 1 in which the pixels for obtaining resolution information account for a half or more of all the pixels.

The signal processing unit 2 includes a pre-processing unit 203, a luminance signal processing unit 204 serving as a first signal processing unit, a color signal processing unit 205 serving as a second signal processing unit, and a signal combining unit 206. A pixel signal received from the imaging device 1 is input to the pre-processing unit 203. The pre-processing unit 203 executes various kinds of correction including offset correction and gain correction for the pixel signal. When the pixel signal output from the imaging device 1 is an analog signal, A/D conversion may be executed by the pre-processing unit 203.

The pre-processing unit 203 appropriately carries out correction such as offset (OFFSET) correction and gain (GAIN) correction for an input pixel signal Din to generate a corrected pixel signal Dout. This processing is expressed typically by the following expression.

Dout=(Din−OFFSET)·GAIN

This correction can be conducted in units of various circuits. For example, the correction may be conducted for each pixel. In addition, the correction may be conducted for each of circuits of a column amplifier, an analog-to-digital conversion unit (ADC), and an output amplifier. Through the correction, so-called fixed pattern noise is reduced, and an image with higher quality can be obtained. The pre-processing unit 203 separates a pixel signal of W for resolution information (luminance signal) and a pixel signal of RGB for color information (color signal) to output the luminance signal to the luminance signal processing unit 204 and output the color signal to the color signal processing unit 205.

The luminance signal processing unit 204 can interpolate the luminance signal in the RGBW12 array with high accuracy. That is, in the RGBW12 array, there are a large number of W pixels for obtaining resolution information, and hence it is possible to obtain information having a higher spatial frequency, namely, a finer pitch, than the CF array having a checkered pattern. In the following, the W pixel generated by interpolation is represented as iW.

The pixel value of iW that has been subjected to signal processing for interpolation is input to the color signal processing unit 205. The color signal processing unit 205 conducts inter-frame averaging processing and false color correction for the RGB pixels, and generates color ratio information to be used for combining the luminance signal and the color signal. The false color correction is conducted by using a pixel value of RGB and the pixel value processed by the luminance signal processing unit 204, that is, the interpolated pixel value of iW. The signal combining unit 206 combines the luminance signal generated by the luminance signal processing unit 204 and the color signal generated by the color signal processing unit 205 to generate an image signal obtained by expressing each pixel as a pixel value of RGB.

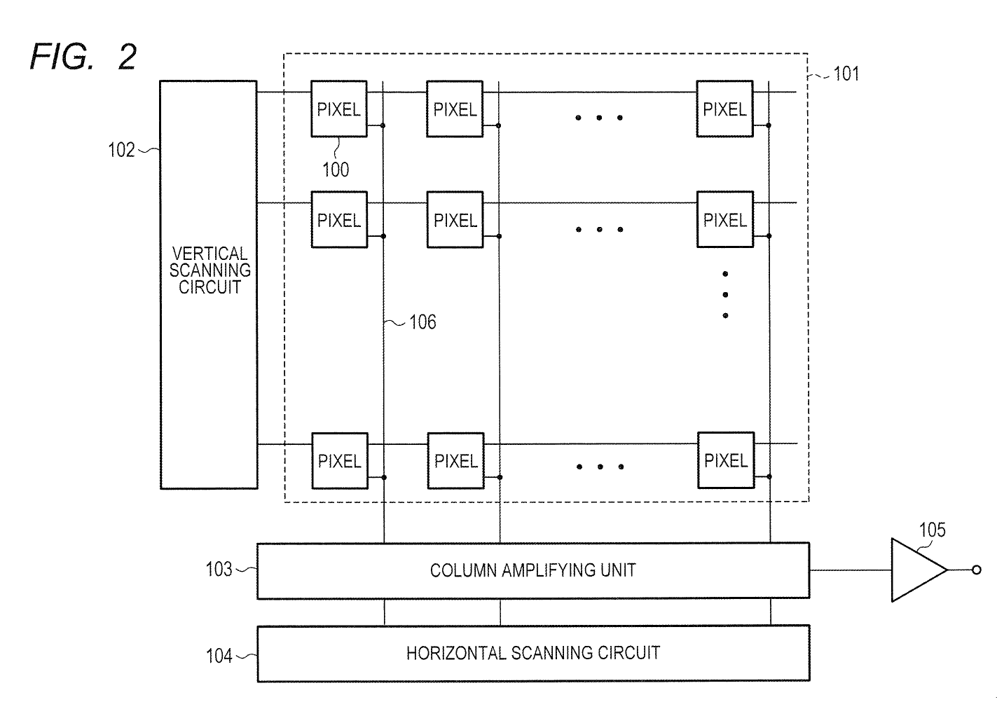

FIG. 2 is a block diagram of the imaging device 1 according to this embodiment. The imaging device includes an image pickup area 101, a vertical scanning circuit 102, a column amplifying unit 103, a horizontal scanning circuit 104, and an output unit 105. As described above, the image pickup area 101 has pixels 100 arranged in a matrix shape, and includes the first pixel group for a luminance signal and the second pixel group for a color signal. The vertical scanning circuit 102 supplies a control signal for controlling a transistor of the pixel 100 between an on state (conducting state) and an off state (non-conducting state). A vertical signal line 106 is provided to each column of the pixels 100, and reads signals from the pixels 100 column by column. The horizontal scanning circuit 104 includes a switch connected to an amplifier of each column, and supplies a control signal for controlling the switch between an on state and an off state. The output unit 105 is formed of a buffer amplifier or a differential amplifier, and outputs the pixel signal received from the column amplifying unit 103 to the signal processing unit 2 outside the imaging device 1. The output pixel signal is subjected to processing such as analog-to-digital conversion and correction of the input data by the signal processing unit 2. Note that, the imaging device 1 may also be a so-called digital sensor including an analog-to-digital conversion circuit. The pixel 100 includes CFs for controlling a spectral sensitivity characteristic, and in this embodiment, CFs of RGBW12 are arranged.

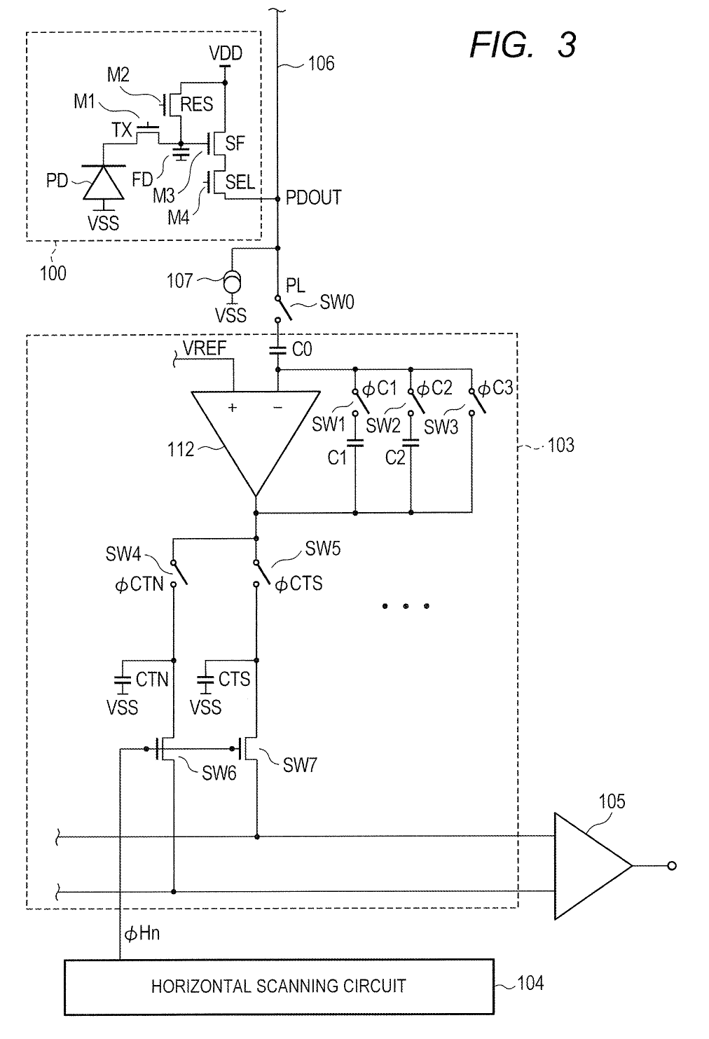

FIG. 3 is a circuit diagram of the pixel 100 and the column amplifying unit 103 of the imaging device according to this embodiment. In this case, in order to facilitate description, a circuit corresponding to one column within the column amplifying unit 103 and one pixel 100 are illustrated. The pixel 100 includes a photodiode PD, a stray diffusion capacitance FD, a transfer transistor M1, a reset transistor M2, an amplifying transistor M3, and a selection transistor M4. Note that, the pixel 100 may also be configured so that a plurality of photodiodes PD share the stray diffusion capacitance FD, the reset transistor M2, the amplifying transistor M3, and the selection transistor M4. Further, the transistors M2 to M4 are not limited to an N-channel MOS, and may also be formed of a P-channel MOS.

The photodiode PD is configured to photoelectrically convert applied light into an electron (charge). A signal TX is supplied to a gate of the transfer transistor M1, and when the signal TX is set to a high level, the transfer transistor M1 transfers the charge generated in the photodiode PD to the stray diffusion capacitance FD. The stray diffusion capacitance FD serves as a drain terminal of the transfer transistor M1, and can hold the charge transferred from the photodiode PD via the transfer transistor M1. A signal RES is supplied to a gate of the reset transistor M2, and when the signal RES is set to a high level, the reset transistor M2 resets the voltage of the stray diffusion capacitance FD to a reset voltage VDD. When the transfer transistor M1 and the reset transistor M2 are simultaneously turned on, the electron of the photodiode PD is reset. A gate of the amplifying transistor M3 is connected to the stray diffusion capacitance FD.

A source of the amplifying transistor M3 is electrically connected to a node PDOUT of the vertical signal line 106 common to each column via the selection transistor M4 to form a source follower. A signal SEL is applied to a gate of the selection transistor M4, and when the signal SEL is set to a high level, the vertical signal line 106 and the amplifying transistor M3 are electrically connected to each other. With this arrangement, a pixel signal is read from the selected pixel 100.

The signal TX, the signal RES, and the signal SEL to be supplied to the pixel 100 are output from the vertical scanning circuit 102. The vertical scanning circuit 102 controls signal levels of those signals, to thereby scan the pixels 100 in units of rows. A current source 107 supplies a current to the pixel 100 via the vertical signal line 106, and the vertical signal line 106 is connected to the column amplifying unit 103 via a switch SW0 driven by the signal PL.

The column amplifying unit 103 includes a column amplifier 112, an input capacitance C0, feedback capacitances C1 and C2, switches SW1 to SW7, and capacitances CTN and CTS. The column amplifier 112 is formed of a differential amplifier circuit including an inverted input node, a non-inverted input node, and an output node. The inverted input node of the column amplifier 112 is electrically connected to the vertical signal line 106 via the input capacitance C0, and a reference voltage VREF is applied to the non-inverted input node. The inverted input node and the output node are connected to each other via three feedback circuits that are connected in parallel. A first feedback circuit is formed of the switch SW1 and the feedback capacitance C1 that are connected in series, a second feedback circuit is formed of the switch SW2 and the feedback capacitance C2 that are connected in series, and a third feedback circuit is formed of the switch SW3. An amplification factor of the column amplifier 112 can be changed by appropriately controlling the on state and the off state of the switches SW1 to SW3. That is, when only the switch SW1 is turned on, the amplification factor becomes C0/C1, and when only the switch SW2 is turned on, the amplification factor becomes C0/C2. When the switches SW1 and SW2 are turned on, the amplification factor becomes C0/(C1+C2), and when only the switch SW3 is turned on, the column amplifier 112 operates as a voltage follower. The switches SW1 to SW3 are controlled by signals φC1 to φC3, respectively.

The output node of the column amplifier 112 is connected to the capacitance CTN via switch SW4 controlled by a signal φCTN. In the same manner, the output node of the column amplifier 112 is connected to the capacitance CTS via the switch SW5 controlled by a signal ACTS. When the stray diffusion capacitance FD is reset, the switch SW4 is turned on, the switch SW5 is turned off, and a pixel signal (N signal) at a time of the resetting is sampled and held the capacitance CTN. After the photoelectrically-converted charge is transferred to the stray diffusion capacitance FD, the switch SW4 is turned off, the switch SW5 is turned on, and a pixel signal (S signal) based on the photoelectrically-converted charge is sampled and held by the capacitance CTS.

The capacitance CTN is connected to a first input node of the output unit 105 via the switch SW6, and the capacitance CTS is connected to a second input node of the output unit 105 via the switch SW7. The horizontal scanning circuit 104 sets a signal φHn of each column to a high level in order, to thereby conduct horizontal scanning. That is, when the signal φHn is set to a high level, the switch SW6 outputs the N signal held by the capacitance CTN to the first input node of the output unit 105, and the switch SW7 outputs the S signal held by the capacitance CTS to the second input node of the output unit 105.

The output unit 105 is formed of a differential amplifier circuit, and amplifies and outputs a differential between the input S signal and N signal, to thereby output a pixel signal from which a noise component at the time of the resetting has been removed. The output unit 105 may be configured to subject the N signal and the S signal to the analog-to-digital conversion and then to correlated double sampling.

As described above, an optical signal input to the imaging device 1 is read as an electric signal. Two-dimensional information of a spectral intensity corresponding to the CF array of RGBW12 is obtained. This embodiment is not limited to the CF array of RGBW12, and can be applied to various CF arrays. Examples of the CF array to which this embodiment can be applied are described below.

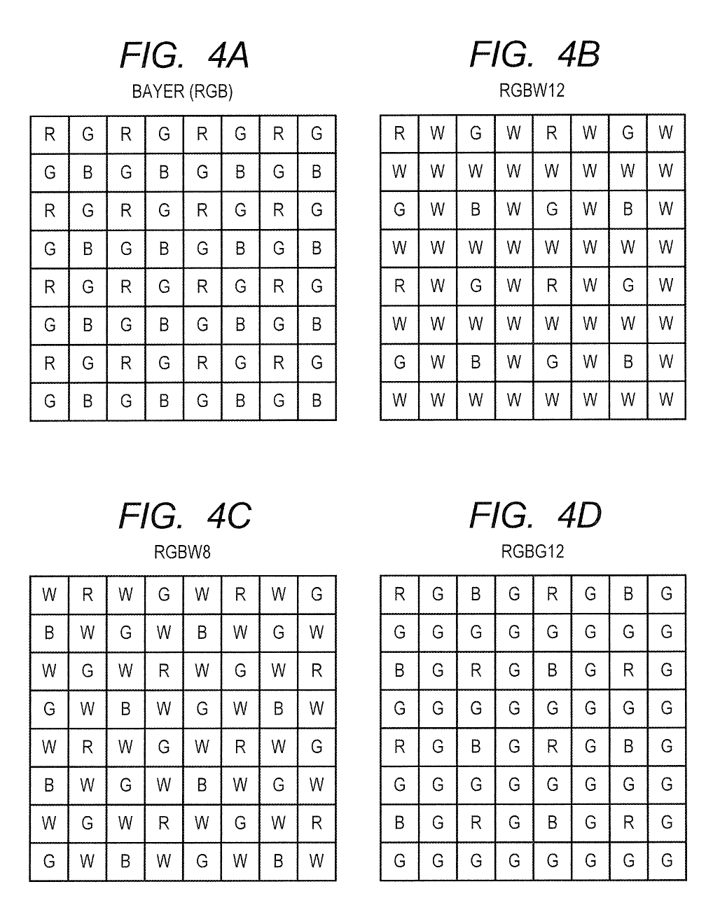

FIG. 4A to FIG. 4D are illustrations of examples of a color filter array using RGB as color pixels. FIG. 4A is an illustration of CFs of a Bayer array, and a ratio of the numbers of CFs is R:G:B=1:2:1. In this case, a larger number of G pixels (first pixels) than the number of RB pixels (second pixels) are arranged because a human visual characteristic has a higher sensitivity to a wavelength of green than wavelengths of red and blue, and because a sense of resolution of an image depends on a luminance of the wavelength of green more strongly than red and blue.

FIG. 4B is an illustration of the CF array of RGBW12. As described above, in this array, the respective CFs are arranged at the ratio of R:G:B:W=1:2:1:12 in the 4×4 pixel array. W pixels (first pixels) are arranged adjacent to each of RGB pixels (second pixels) being color pixels in a vertical direction, a horizontal direction, and an oblique direction in a plan view. That is, the RGB pixels are each surrounded by eight W pixels. The proportion of the W pixels accounts for ¾ of all the pixels. The RGB pixels being color pixels are each surrounded by the W pixels, and hence the signal of the W pixel for the RGB pixel can be interpolated with higher accuracy than the CF array of FIG. 4A.

FIG. 4C is an illustration of a CF array of RGBW8. In the 4×4 pixel array, respective CFs are arrayed at the ratio of R:G:B:W=2:4:2:8. The W pixels (first pixels) are arranged in a checkered pattern, and an RGB pixel (second pixel) is arranged among the W pixels. The proportion of the W pixels is ½ of all the pixels. The W pixels are arranged in a checkered pattern in the same manner as the G pixels within the Bayer array, and hence a method of interpolating the G pixel of the Bayer array can be used as it is. The arrangement of the W pixels allows an improvement in the sensitivity.

FIG. 4D is an illustration of a CF array of RGBG12. In this array, the W pixels of RGBW12 are replaced by G pixels (first pixels), and in the 4×4 pixel array, CFs of the respective colors are arranged at the ratio of R:G:B=2:12:2. RB pixels (second pixels) are each surrounded by the G pixels, and the proportion of the G pixels accounts for ¾ of all the pixels. The RB pixels are each surrounded by the G pixels, and hence the accuracy improves in the interpolation of the G value of the color pixel. The proportion of the G pixels, which have a higher sensitivity than the RB pixels, is large, and hence the sensitivity can be improved.

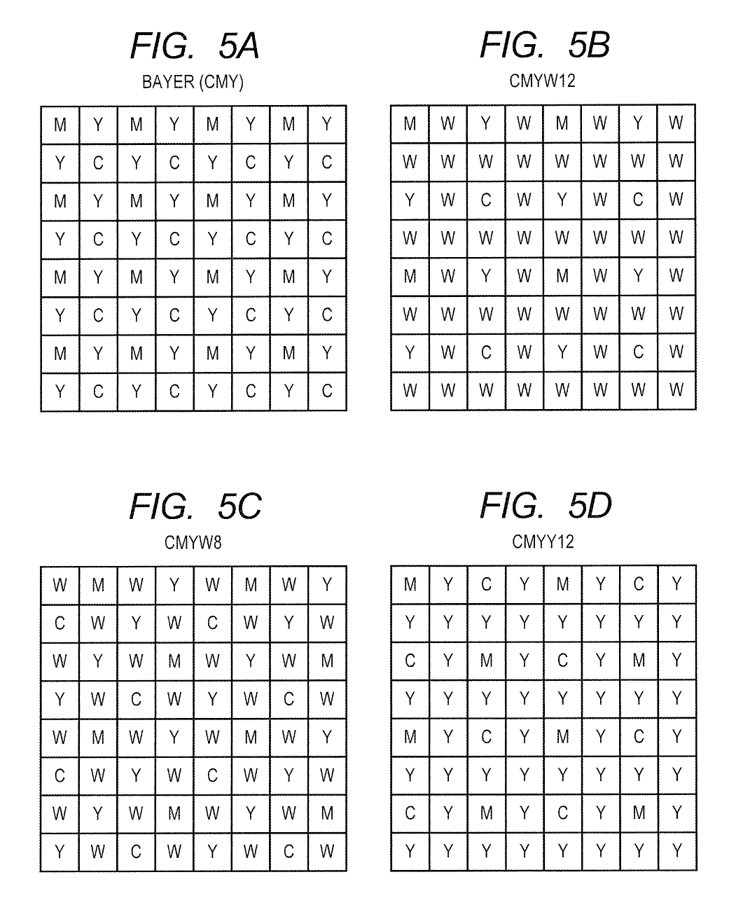

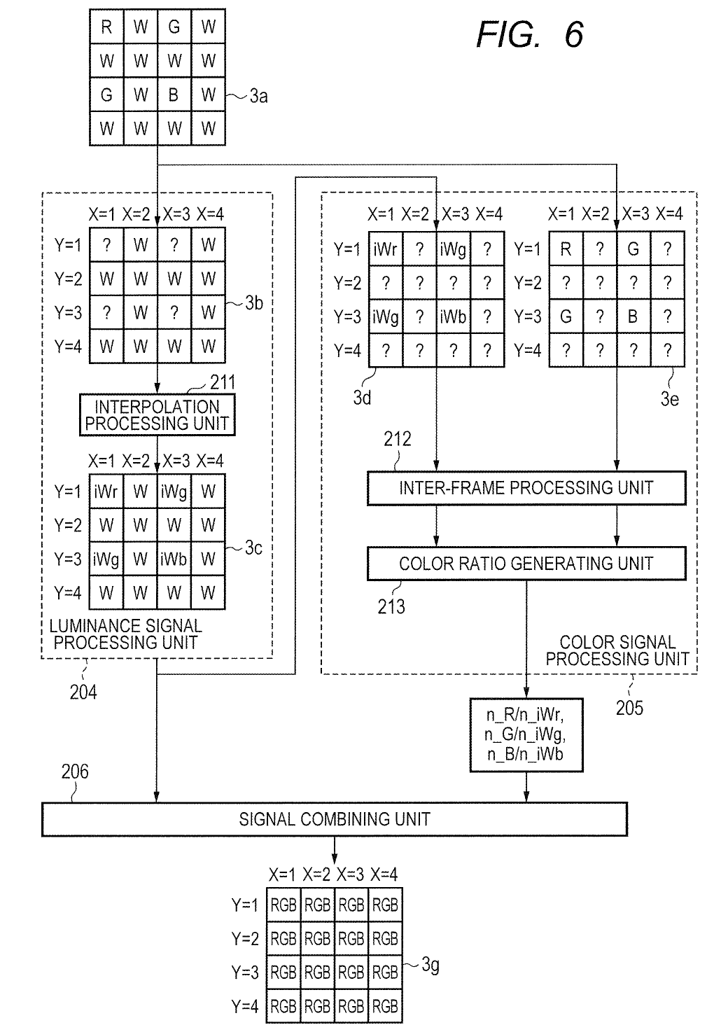

FIG. 5A to FIG. 5D are illustrations of examples of a CF array using cyan (C), magenta (M), and yellow (Y) which are complementary colors, as color pixels. FIG. 5A is an illustration of the Bayer array, and the ratio of the CFs of the respective colors is C:M:Y=1:1:2. In this case, a large number of Y pixels (first pixels) are arranged because the Y pixel has a high sensitivity in the same manner as the G pixel.

FIG. 5B is an illustration of a CF array of CMYW12. In the 4×4 pixel array, the CFs of the respective colors are arrayed at the ratio of C:M:Y:W=1:1:2:12. The array has a feature that CMY pixels (second pixels) being color pixels are each surrounded by W pixels (first pixels), and the proportion of the W pixels accounts for ¾ of all the pixels. The CMY pixels are each surrounded by the W pixels, and hence the accuracy can be improved in the interpolation of a W pixel value in the position of the CMY pixel. The arrangement of the W pixels allows an improvement in the sensitivity.

FIG. 5C is an illustration of a CF array of CMYW8. In the 4×4 pixel array, the CFs of the respective colors are arrayed at the ratio of C:M:Y:W=2:2:4:8. The W pixels (first pixels) are arranged in a checkered pattern, and the CMY pixels (second pixels) are each surrounded by the W pixels. The proportion of the W pixels is ½ of all the pixels. The W pixels are arranged in a checkered pattern in the same manner as the G pixels within the Bayer array, and hence a method of interpolating the G pixel of the Bayer array can be used as it is. The arrangement of the W pixels allows an improvement in the sensitivity.

FIG. 5D is an illustration of a CF array of CMYY12. The W pixels of CMYW12 are replaced by Y pixels (first pixels), and in the 4×4 pixel array, the respective CFs are arranged at the ratio of C:M:Y=2:2:12. The array has a feature that the C pixel and the M pixel (second pixels) are each surrounded by the Y pixels, and the proportion of the arranged Y pixels accounts for ¾ of all the pixels. The C pixel and the M pixel are each surrounded by the Y pixels, and hence the accuracy can be improved in the interpolation of the pixel value of Y in the position of each of the C pixel and the M pixel. The proportion of the Y pixels, which have a relatively higher sensitivity than the C pixel and the M pixel, is large, and hence the sensitivity improves.

As described above, various CF arrays can be employed in this embodiment, but in order to generate an image having a high resolution, it is preferred to arrange a larger number of pixels (first pixels) that contribute to the resolution to a larger extent. It is desired that the first pixel group include more resolution information than the second pixel group, and that the second pixel group include at least two kinds of pixels different in spectral sensitivity. It is desired that the first pixel group have a higher degree of contribution to the luminance than the second pixel group. In any one of the CF arrays, the first pixel group outputs the first pixel signal based on the light having the first wavelength band, which includes at least the wavelength band corresponding to green, and the second pixel group outputs the second pixel signal based on the light having a wavelength band narrower than the first wavelength band or the light having a wavelength band different from the first wavelength band.

In the Bayer array, the G pixels that contribute to the resolution are arranged in a checkered pattern, which is liable to cause an interpolation error. The inventors of the present invention found that the interpolation error can be minimized by using a CF array that yields a higher resolution than the checkered pattern. Therefore, the effects of the present invention are particularly noticeable by using the CF arrays exemplified in RGBW12 of FIG. 4B, RGBG12 of FIG. 4D, CMYW12 of FIG. 5B, and CMYY12 of FIG. 5D.

FIG. 6 is a block diagram of the signal processing unit 2 of the imaging apparatus according to this embodiment. The signal processing unit 2 includes the luminance signal processing unit 204, the color signal processing unit 205, and the signal combining unit 206, and is configured to conduct demosaicing processing for a pixel signal 3a received from the imaging device 1 to generate an image signal 3g including information of RGB for each pixel. The signal processing unit 2 can be configured by hardware such as an image processing processor, but the same configuration can be implemented with general-purpose processor or software on a computer.

The pixel signal 3a, which includes a CF array of RGBW12 and is expressed by digital data, is input to the luminance signal processing unit 204. In FIG. 6, 4×4 pixels serving as one unit of repetition of the CF array are illustrated, but in the actual pixel signal 3a, the array of the 4×4 pixels is repeated. The input pixel signal 3a is separated into a pixel signal 3b of W and a pixel signal 3e of RGB by the pre-processing unit 203 (not shown), and the pixel signal 3b and the pixel signal 3e are output to the luminance signal processing unit 204 and the color signal processing unit 205, respectively.

There is no pixel value of W existing in positions from which RGB pixels has been separated within the pixel signal 3b of W, and in FIG. 6, those positions are each represented by “?”. An interpolation processing unit 211 interpolates the pixel value in the position of “?” based on the surrounding pixel values of W to generate pixel values of iWr, iWg, and iWb by interpolation. For example, there is no W pixel existing at coordinates (3,3) within the pixel signal 3b, and hence the pixel value of iWb (3,3) at the coordinates (3,3) is obtained from an average value of the surrounding eight W pixel values as expressed by the following expression.

$${iWb}_{( 3 , 3 )} = \frac{{W}_{( 2 , 2 )} + {W}_{( 3 , 2 )} + {W}_{( 4 , 2 )} + {W}_{( 2 , 3 )} + {W}_{( 4 , 3 )} + {W}_{( 2 , 4 )} + {W}_{( 3 , 4 )} + {W}_{( 4 , 4 )}}{8}$$

In FIG. 6, the 4×4 pixel array is illustrated, but in actuality, the pixel array is repeated, and each of an R pixel at coordinates (1,1), a G pixel at coordinates (3,1), and a G pixel at coordinates (1,3) is surrounded by eight W pixels. Therefore, the pixel values of iWr and iWg can also be generated by interpolation using the surrounding eight pixel values of W in the same manner. Examples of an interpolation processing method that can be appropriately used include not only the above-mentioned method but also a bilinear method, a bicubic method, and a method of obtaining an average of pixels exhibiting a small rate of change in a vertical direction, a horizontal direction, and an oblique direction. This enables interpolation with high accuracy even with a high-definition object having a high spatial frequency.

The color signal processing unit 205 includes an inter-frame processing unit 212 and a color ratio generating unit 213. The inter-frame processing unit 212 uses a pixel signal 3d interpolated by the luminance signal processing unit 204 and the pixel signal 3e formed of RGB pixels to generate color information. That is, the inter-frame processing unit 212 uses the second pixel signals in the respective frames used for generating first data on a plurality of frames by the luminance signal processing unit 204 to generate second data on a plurality of frames. The pixel signal 3d is the first data obtained by interpolating the pixel signal corresponding to the first wavelength band in the second pixel group by using the pixel signal corresponding to the first wavelength band output by the first pixel group during one frame period. The pixel signal 3e is the second data generated by using the second pixel signal output from the second pixel group during one frame period. The second data includes information of the ratio between the first data and the second pixel signal in each of the pixels of the second pixel group. In general, in a local area where no RGB pixel exists, the first pixel group has a hue maintained at a substantially constant level, and also has a strong color correlation. Therefore, in this embodiment, processing for assigning the color ratio of the RGB pixels to the area where no RGB pixel exists is conducted on the assumption that a color ratio in an area where an RGB pixel value exists is the same as a color ratio in the periphery where no RGB pixel exists.

The inter-frame processing unit 212 includes a frame memory, and is configured to conduct inter-frame processing (averaging processing) for each of the pixel signal 3d of iW subjected to the interpolation and the pixel signal 3e of RGB pixels. The imaging device according to this embodiment includes W pixels, and therefore has a smaller sum of the number of pixels of RGB than a sum of the number of pixels of RGB of the Bayer array illustrated in FIG. 4A. Therefore, random noise and photon shot noise of RGB pixels are liable to become more conspicuous than in the case of using the Bayer array. The random noise and the photon shot noise are hereinafter referred to collectively as “color noise”. In order to reduce the color noise, the imaging apparatus according to this embodiment conducts noise reduction (NR) using color signals included in a plurality of frames that are temporally continuous. A method for noise reduction using the inter-frame processing is described below.

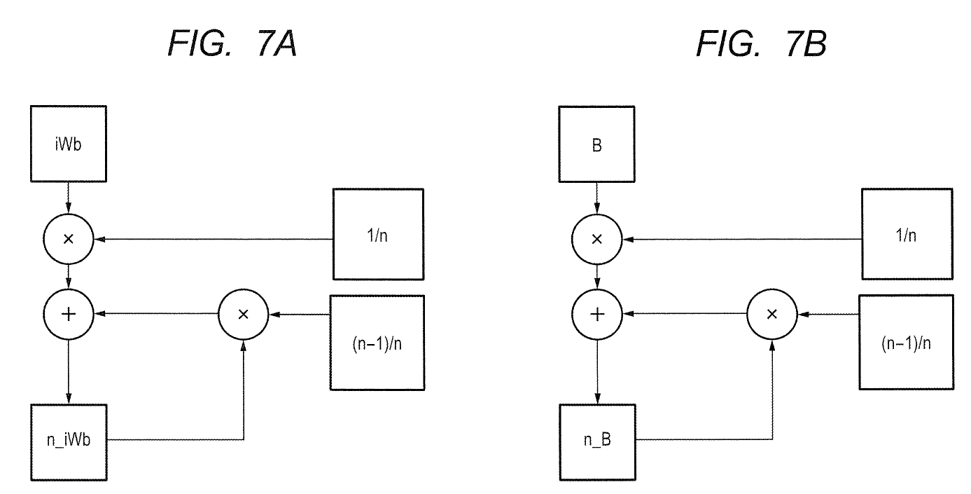

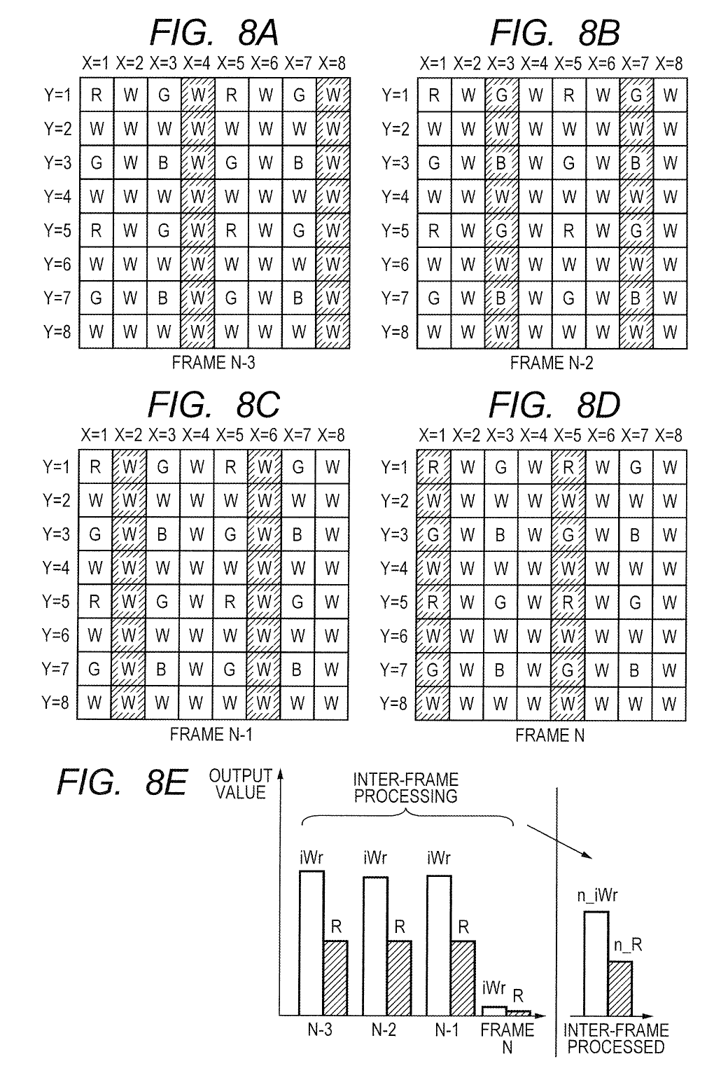

FIG. 7A and FIG. 7B are illustrations of examples of the inter-frame processing. FIG. 7A is an illustration of the averaging processing for the interpolated pixel iWb at the coordinates (3,3) of the pixel signal 3d. The inter-frame processing unit 212 includes a so-called IIR filter (recursive filter), and is configured to conduct weighted addition for image signals in the current frame and another frame at a different time. The inter-frame processing unit 212 adds a value obtained by multiplying the pixel value of iWb accumulated in the frame memory by the factor (n−1)/n and a value obtained by multiplying the current pixel value of iWb by the factor 1/n to obtain an inter-frame processed pixel value of n_iWb. FIG. 7B is an illustration of the averaging processing for image information of a B pixel at the coordinates (3,3) of the pixel signal 3e. The B pixel is also subjected to the above-mentioned inter-frame averaging processing. The inter-frame processing unit 212 adds a value obtained by multiplying the pixel value of B accumulated in the frame memory by the factor (n−1)/n and a value obtained by multiplying the current pixel value of B by the factor 1/n to obtain a pixel value of n_B subjected to the inter-frame processing. The other pixel values of iWr, iWg, R, and G are also each subjected to the inter-frame processing in the same manner. In this embodiment, a number n of frames in the inter-frame processing for the interpolated pixel and a number n of frames in the inter-frame processing for the RGB pixel are the same, and weights on the frames are equal to each other. Further, each of the n frames in the inter-frame processing for the interpolated pixel and each of the n frames in the inter-frame processing for the RGB pixel are the same frames.

An operation of the inter-frame processing unit 212 is described below in detail. First, the inter-frame processing unit 212 stores in advance the pixel signal of RGB in the first frame into the frame memory. In this case, the pixel signal in the first frame is not subjected to processing for multiplication or division described later. The inter-frame processing unit 212 multiplies the pixel value of RGB in the second frame by the factor 1/n. For example, when n is 2, the pixel value of RGB becomes ½. Then, the color signal processing unit 205 multiplies the pixel signal of RGB in the first frame stored in the frame memory by the factor (n−1)/n. Because n is 2, the pixel values of R, G, and B in the first frame each become ½. The inter-frame processing unit 212 adds the pixel signal of the RGB in the first frame, which has been multiplied by ½, and the pixel value in the second frame, which has been multiplied by ½. With this operation, it is possible to acquire the pixel values of n_R, n_G, and n_B obtained by averaging the pixel values of RGB, respectively, between the first frame and the second frame. Subsequently, in the next frame, values obtained by multiplying the pixel values of n_R, n_G, and n_B in the preceding frame by ½ are further added. In this manner, the pixel value in the preceding frame is fed back to the pixel value in the next frame, and the addition averaging is conducted. When n is at least 3, the inter-frame processing unit 212 multiplies a pixel value obtained by averaging the pixel values in the first frame and the second frame by ⅔, and adds this multiplication result and a pixel value obtained by multiplying the pixel value in the third frame being a final frame by ⅓. With this operation, data obtained by averaging the pixel signals included in the third frame is acquired.

The color ratio generating unit 213 calculates the color ratio information between the first data and the second pixel signal in each of the pixels of the second pixel group. That is, the color ratio information of R is expressed by n_R/n_iWr at the coordinates (1,1), and the color ratio information of B is expressed by n_B/n_iWb at the coordinates (3,3). Further, the color ratio information of G is expressed by an average value between a pixel value n_G/n_iWg at the coordinates (3,1) and a pixel value n_G/n_iWg at the coordinates (1,3). Therefore, color ratio information RGB_ratio of the respective colors is expressed by the following expression.

RGB_ratio=[n_R/n_iWr n_G/n_iWg n_B/n_iWb]

The signal combining unit 206 generates the image signal 3g including information of the respective colors of RGB for each pixel on the assumption that the ratio among the respective colors is constant within the 4×4 area. That is, the signal combining unit 206 uses a pixel signal 3c of W and iW generated by the luminance signal processing unit 204 and the color ratio information RGB_ratio generated by the color signal processing unit 205 to obtain the value of RGB for each pixel and generate the image signal 3g. When the pixel of the pixel signal 3c is W, the pixel value of RGB is obtained by the following expression.

RGB=[R_ratio·W G_ratio·W B_ratio·W]

When the pixel of the pixel signal 3c is iW, the pixel value of RGB is obtained by the following expression.

RGB=[R_ratio·iW G_ratio·iW B_ratio·iW]

With this processing, the image signal 3g including information of the respective colors of RGB for each pixel is obtained. In this embodiment, in order to estimate the color information, the processing is conducted on the assumption that a correlation between the luminance and the hue is strong in the local area. That is, the color information can be assumed to be locally constant. In the human visual characteristic, the respective resolution powers of the resolution (luminance) and the color (hue) are different, and the resolution power of the color is lower than the resolution power of the luminance. In order to obtain a sense of high resolution, it is desired to improve the resolution of the luminance signal. According to this embodiment, a color moving image having a sense of high resolution can be obtained by using the W pixel having a high resolution and a high luminance and the color information for each 4×4 block. In this embodiment, the processing is conducted on the assumption that the color ratio is constant in the 4×4 block, but the color ratio information of each pixel may be corrected by using information on the adjacent blocks.

FIG. 8A to FIG. 8E are diagrams and a graph for illustrating and showing an action of the inter-frame processing according to this embodiment. FIG. 8A to FIG. 8D are illustrations of the pixel signal obtained when a striped pattern of white:black=3:1 moves in a horizontal direction every frame. FIG. 8E is a graph for showing the pixel signal of an R pixel at coordinates (5,1) for each frame and the pixel signal subjected to the inter-frame averaging processing. In the (N−3)th frame to the (N−1)th frame, a white pattern exists at the coordinates (5,1), and hence the color signal can be estimated based on the color ratio information of an interpolated pixel iWr and the R pixel. Meanwhile, in the N-th frame, a black pattern exists at the coordinates (5,1), and hence the signal value of the R pixel becomes small, resulting in a difficulty in estimating the color ratio. Therefore, such an object illustrated in FIG. 8A to FIG. 8D causes a false color in the N-th frame.

The pixel signal in the N-th frame obtained when the inter-frame averaging processing is conducted is shown as n_iWr and n_R in FIG. 8E. When the inter-frame averaging processing is not conducted, information amounts of the pixel of R and the pixel of iWr are small, and hence the accuracy of color estimation is lowered. According to this embodiment, the inter-frame processing is conducted, to thereby be able to refer to the information of the white pattern from the (N−3)th frame to the (N−1)th frame. It is thus possible to improve the accuracy of the color estimation.

In FIG. 8A to FIG. 8E, a specific object pattern is described by taking an example, but it should be understood that the effects of the present invention are also produced with a pattern having a high spatial frequency including other cycle patterns in a vertical direction, a horizontal direction, and an oblique direction. The same effects are obtained not only when the object or the imaging apparatus is moved intentionally but also when an unintentional shake of the imaging apparatus or an image blur due to the atmospheric fluctuation or the like exists.

In this embodiment, an RGB value is output for each pixel, but in view of compatibility with the signal processing unit 2 in the subsequent stage, the image signal obtained by conducting remosaicing to the Bayer array may be output.

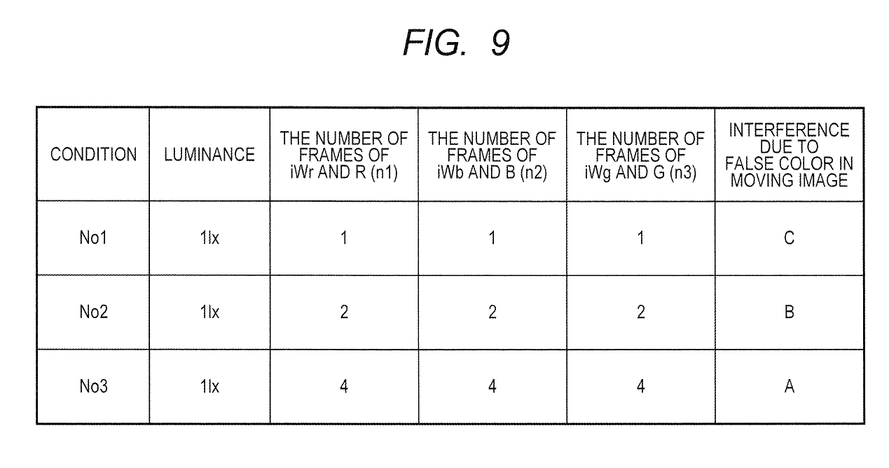

FIG. 9 is a table for showing evaluation results of the imaging apparatus according to this embodiment. As evaluation items for an image, interference due to a false color caused when a moving image is being photographed is used. The interference due to the false color in the moving image is represented by “A” (substantially none), “B” (acceptable), and “C” (annoying) in order from an excellent evaluation. The evaluation is conducted with a luminance and numbers n1, n2, and n3 of frames being changed as evaluation conditions. In this case, the numbers n1, n2, and n3 of frames represent the number n of frames within the factors 1/n and (n−1)/n used in the inter-frame processing, and n1, n2, and n3 are equal to one another in this embodiment. As the number n of frames becomes larger, the weight on other frames in the inter-frame processing becomes larger.

As Condition No1, an ambient luminance was set to 1 [1x], and the number of frames was set as n=1. In this condition, a large number of false colors were exhibited when an object pattern having a high frequency moved, and flickers of the false colors in the moving image were extremely unsatisfactory. Therefore, the interference due to the false color was at the annoying level “C”. As Condition No2, the ambient luminance was set to 1 [1x], and the number of frames was set as n=2. In this condition, the false colors and the flickers, which were exhibited when the object pattern having a high frequency moved, were decreased. The false colors were visually recognizable, but were at an acceptable level. Therefore, the interference due to the false color was at the acceptable level “B”. As Condition No3, the ambient luminance was set to 1 [1x], and the number of frames was set as n=4. The false colors and the flickers, which were exhibited when the object pattern having a high frequency moved, were at a substantially negligible level. Therefore, the interference due to the false color was at the substantially none level “A”.

The color signal processing unit 205 calculates the color ratio information after conducting the inter-frame processing, but this embodiment is not limited to this method. For example, the inter-frame processing may be conducted after the color ratio information is calculated. That is, the values of the color ratio information of R/iWr, B/iWb, and G/iWg may be stored into the frame memory, and the inter-frame averaging processing may be conducted for the color ratio information. The inter-frame processing is not limited to the IIR filter, and a non-recursive filter (FIR) may be used, or an inter-frame moving average may used. An inter-frame median filter may be used. This embodiment has been described by taking a case where the number n of frames for the inter-frame processing is 1, 2, and 4, but an adaptive filter configured to change the value of depending on an environment (luminance, contrast, or moving speed) of an object may be used.

According to this embodiment, the use of the W pixels allows an imaging apparatus having a high sensitivity and a high resolution to be provided. It is possible to improve the estimation accuracy of the color signal by interpolating the luminance signal in the position of the color pixel with high accuracy. In addition, it is possible to suppress the false color in the moving image by conducting the inter-frame processing for the interpolated W pixel and the color pixel. In this embodiment, the number n of frames for the inter-frame processing for the interpolated pixel and the number n of frames for the inter-frame processing for the RGB pixel are set to be the same, but this embodiment is not limited to this example. It suffices that the number of frames in the inter-frame processing for the interpolated pixel is at least two, and that the number of frames in the inter-frame processing for the RGB pixel is at least two.

### Second Embodiment

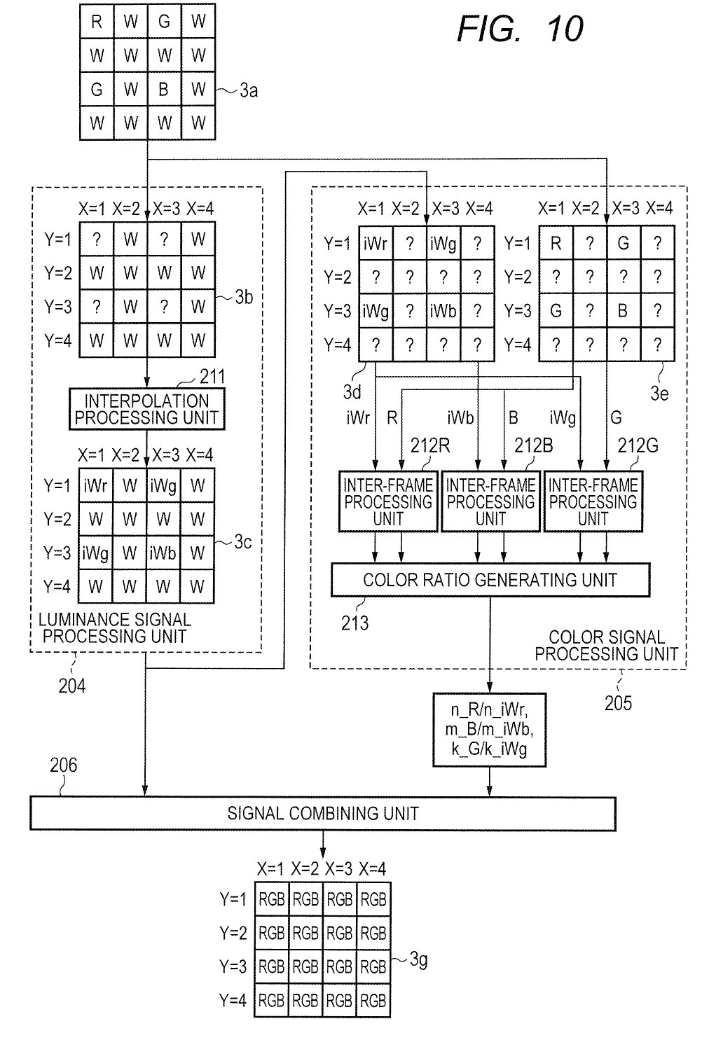

FIG. 10 is a block diagram of a signal processing unit 2 of an imaging apparatus according to a second embodiment of the present invention. The imaging apparatus according to this embodiment is described below mainly in terms of points different from those of the first embodiment. The color signal processing unit 205 according to this embodiment is different from the first embodiment in that the color signal processing unit 205 includes inter-frame processing units 212R, 212G, and 212B of the respective colors of RGB. In this manner, the number of frames for the inter-frame processing can be changed by the inter-frame processing units 212R, 212G, and 212B for each of the colors of the RGB.

The inter-frame processing unit 212R conducts the inter-frame processing for the R pixel and the pixel of iWr in the same position, and the inter-frame processing unit 212B conducts the inter-frame processing for the B pixel and the pixel of iWb in the same position. The inter-frame processing unit 212G conducts the inter-frame processing for the G pixel and the pixel of iWg in the same position. The inter-frame processing units 212R, 212G, and 212B have a processing skip mode, and can be set to skip the inter-frame processing.

In the CF array of RGBW12, the pixel ratio of R:G:B is 1:2:1. Therefore, the numbers of frames for the inter-frame processing for the R pixels and B pixels, the numbers of which are small, are increased (the weights are increased), to thereby be able to enhance the effect of suppressing a false color. Meanwhile, in regard to the G pixels having a relatively large number of pixels, the inter-frame processing is not conducted, or the number of frames for the inter-frame processing is reduced (the weight is reduced), to thereby be able to obtain the effect of suppressing a false color in the moving image while reducing a circuit scale.

The number of frames for the inter-frame processing may be changed for each color depending on a color temperature (spectral sensitivity characteristic) of a light source at a time of photographing. An output from a solid-state imaging device changes depending on the color temperature of the light source. For example, the light source of an incandescent lamp has such a characteristic that an output having a long wavelength (R pixel) is relatively larger than sunlight, and that an output having a short wavelength (B pixel) is relatively smaller than sunlight. When the light source having a strong long wavelength and a weak short wavelength is used, the number of frames processed for the B pixel is caused to become larger than those of the G pixel and the R pixel, to thereby be able to enhance the effect of reducing false colors. The color ratio generating unit 213 calculates the color ratio information RGB_ratio by arithmetically operating the color ratio in each pixel position. That is, the second data includes information of the ratio between the second pixel signal and an average of a plurality of pieces of the first data in each of the pixels of the second pixel group.

$$RGB\_ratio = [ \begin{matrix}\frac{n\_R}{n\_iWr} & \frac{k\_G}{k\_iWg} & \frac{m\_B}{m\_iWb}\end{matrix} ]$$

The signal combining unit 206 generates the image signal 3g including the information of the respective colors of RGB for each pixel on the assumption that the ratio among the respective colors is constant within the 4×4 area. That is, the signal combining unit 206 generates the image signal 3g by combining the pixel signal 3d being the first data on a plurality of frames and the pixel signal 3e being the second data on a plurality of frames. As described in the first embodiment, correction processing may be conducted through the use of the information on the adjacent blocks to calculate the color ratio information at each of the coordinates. The signal combining unit 206 uses the pixel signal 3c of W and iW generated by the luminance signal processing unit 204 and the color ratio information RGB_ratio to obtain the pixel value of RGB for each given pixel in the following manner. The pixel value of RGB is obtained by one of the following expressions depending on which of K and the given pixel is.

RGB=[R_ratio·W G_ratio·W B_ratio·W]

RGB=[R_ratio·iW G_ratio·iW B_ratio·iW]

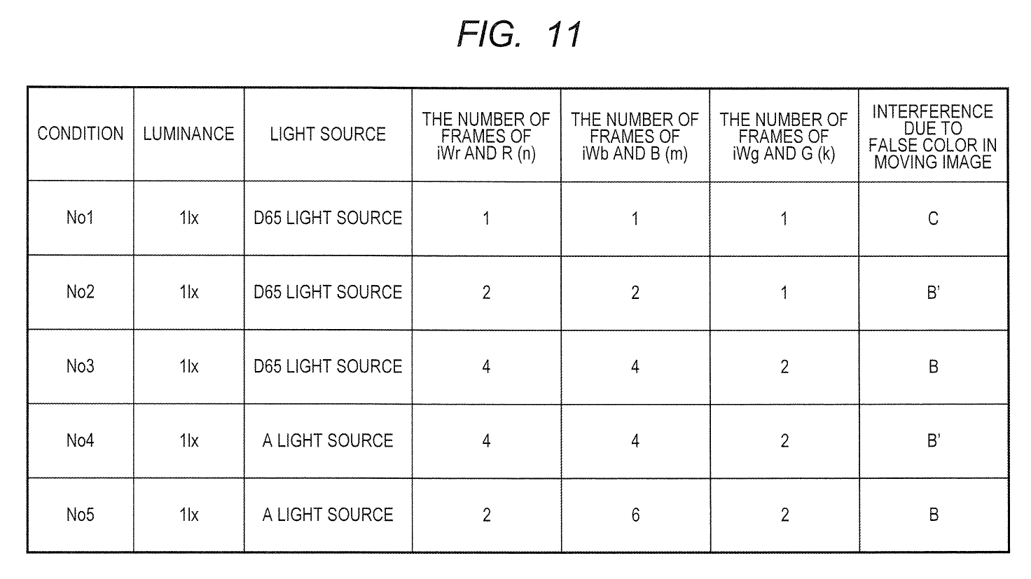

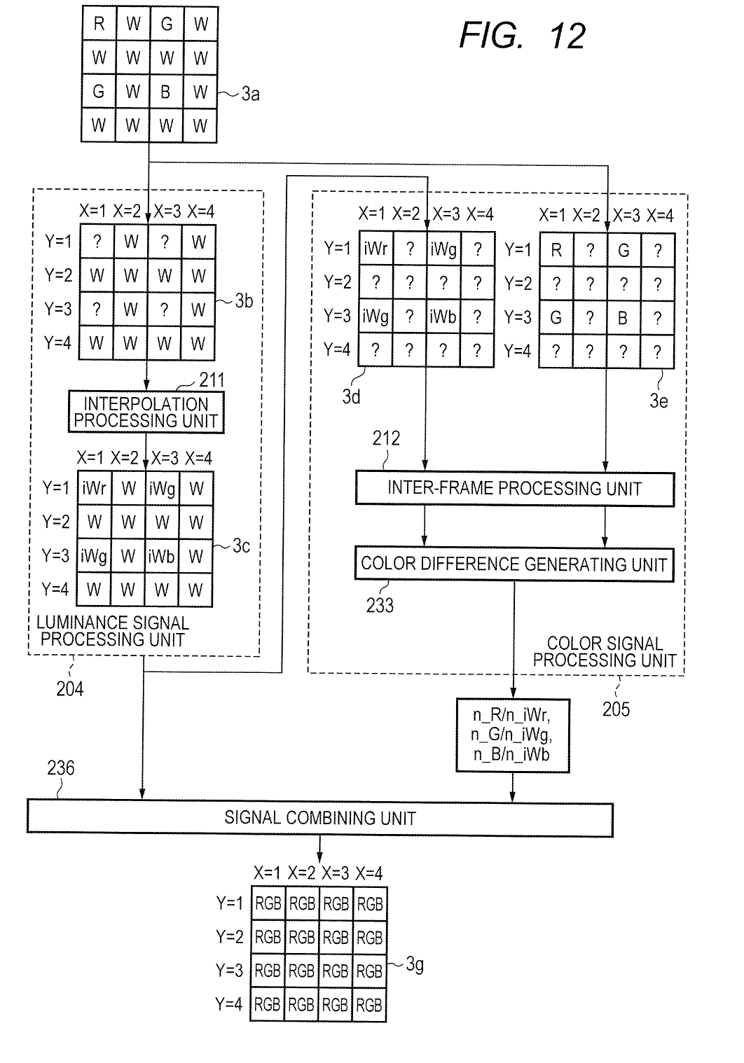

FIG. 11 is a table for showing evaluation results of the imaging apparatus according to this embodiment. As the evaluation items for an image, the interference due to a false color caused when a moving image was acquired was used. The interference due to the false color in the moving image is represented by “B” (acceptable), “B′” (tolerable), and “C” (annoying) in order from an excellent evaluation. The evaluation was conducted with the luminance, the light source, and numbers n, m, and k of frames being changed as the evaluation conditions. As a standard light source, a D65 light source and an A light source were used. The D65 light source is a light source that has a color temperature of 6,504 K and is close to natural daylight, and the A light source is a light source of an incandescent tungsten lamp having a color temperature of 2,854 K. That is, the A light source has such a characteristic that the intensity of the short wavelength (B pixel) is weaker and the intensity of the long wavelength (R pixel) is stronger than the D65 light source. The numbers n, m, and k of frames correspond to the number n of frames within the factors 1/n and (n−1)/n used in the inter-frame processing for the respective pixels of RGB, and the evaluation was conducted with the respective values being changed.

In Condition No1, the D65 light source was used as the light source, the ambient luminance was set to 1 [1x], and the numbers of frames were set as n=m=k=1. The evaluation result was that the degree of the false color exhibited when the object pattern having a high frequency moved was unsatisfactory, and that the flicker of the false color in the moving image was also extremely unsatisfactory. The interference due to the false color was evaluated as the annoying level “C”.

In Condition No2, the D65 light source was used as the light source, the ambient luminance was set to 1 [1x], and the numbers of frames were set as n=m=2 and k=1. When the object pattern having a high frequency moved, the false colors of the RB pixels were decreased even though the false color of the G pixel was somewhat conspicuous, and the false color in the moving image reached a tolerable level. The spatial frequency of the pixel arrangement of the G pixels is twice as high as those of the RB pixels, and hence it is conceivable that the false color was no longer conspicuous even when the number of frames processed for the G pixel was reduced. The evaluation result was that the interference due to the false color was at the tolerable level “B′”.

In Condition No3, the D65 light source was used as the light source, the ambient luminance was set to 1 [1x], and the numbers of frames were set as n=m=4 and k=2. When the object pattern having a high frequency moved, the false color was no longer conspicuous, and reached an acceptable level. The evaluation result was that the interference due to the false color was at the acceptable level “B”.

In Condition No4, the A light source was used as the light source, the ambient luminance was set to 1 [1x], and the numbers of frames were set as n=m=4 and k=2. When the object pattern having a high frequency moved, the false color of the B pixel was somewhat conspicuous, but reached a tolerable level. It is conceivable that this is because the A light source has such a characteristic that the intensity of the short wavelength (B pixel) is weaker and the intensity of the long wavelength (R pixel) is stronger than the D65 light source, and hence the output of the B pixel was reduced, which was liable to cause a false color. The evaluation result was that the interference due to the false color was at the tolerable level “B′”.

As Condition No5, the A light source was used as the light source, the ambient luminance was set to 1 [1x], and the numbers of frames were set as n=2, m=6, and k=2. When the object pattern having a high frequency moved, the false color was no longer conspicuous, and reached an acceptable level. The A light source having a weak intensity of the short wavelength was used, and hence the output of the B pixel was reduced. However, it is conceivable that a satisfactory color balance was obtained by increasing the number of frames processed for the B pixel and reducing the number of frames processed for the R pixel exhibiting a large output. The evaluation result was that the interference due to the false color was at the acceptable level “B”.

Also in this embodiment, the same effects as those of the first embodiment can be produced. That is the use of the W pixels allows an imaging apparatus having a high sensitivity and a high resolution to be obtained. It is possible to improve the estimation accuracy of the color signal by interpolating the luminance signal in the position of the color pixel with high accuracy, and also to suppress the false color in the moving image by conducting the inter-frame averaging processing for the interpolated W pixel and the color pixel. In addition, in this embodiment, the inter-frame processing is conducted in consideration of a difference in the arrangement of the respective RGB pixels, and the number of frames (weight) is changed for each color in consideration of a photographing condition, to thereby be able to further reduce false colors. The reduction in the number of frames also allows lower power consumption to be realized at the same time.

Under a low illuminance environment, in order to obtain noise reduction effects, the inter-frame processing for the W pixel may be conducted by the luminance signal processing unit 204. In that case, in order to maintain a sense of resolution, it is desired that the number of frames for the inter-frame processing for the W pixel be smaller than the number of frames for the inter-frame processing for the color signal.

### Third Embodiment

FIG. 12 is a block diagram of a signal processing unit 2 of an imaging apparatus according to a third embodiment of the present invention. The imaging apparatus according to this embodiment is described below mainly in terms of points different from those of the first embodiment. This embodiment is different from the first embodiment in that the color signal processing unit 205 includes a color difference generating unit 233, and a signal combining unit 236 is configured to generate the image signal 3g based on color difference information. The inter-frame processing unit 212 conducts the inter-frame processing for each of the pixel signal 3d interpolated by the luminance signal processing unit 204 and the pixel signal 3e formed of RGB pixels. The color difference generating unit 233 calculates color difference information RGB_diff on the signals of the pixels n_R, n_G, and n_B of RGB subjected to the inter-frame processing and the interpolated pixels n_iWr, n_iWg, and n_iWb of RGB subjected to the inter-frame processing. That is, the second data includes a difference between the second pixel signal and the average of a plurality of pieces of the first data in each of the pixels of the second pixel group.

RGB_diff=[n_R−n_iWr, n_G−n_iWg, n_B−n_iWb]

The signal combining unit 236 generates the image signal 3g including the pixel values of RGB by using the color difference information on the assumption that the color difference among the respective colors is constant within the 4×4 area. That is, the signal combining unit 236 uses the pixel signal 3c of W and iW and the color difference information RGB_diff to obtain the value of RGB for each pixel in the following manner and generate the image signal 3g.

RGB=[R_diff+W, G_diff+W, B_diff+W]

A method of calculating the color difference information at the respective coordinates is not limited to the above-mentioned processing, and the color difference information on each pixel may be corrected through the use of the information on the adjacent blocks. As described above, the correlation between the luminance and the hue is strong in the local area, and hence the color information can be assumed to be locally constant. In the human visual characteristic, the respective resolution powers of the luminance and the color (hue) are different, and the resolution power of the color is lower than the resolution power of the luminance. Therefore, in order to obtain a sense of high resolution, it is desired to improve the resolution of the luminance signal. According to this embodiment, a color moving image having a sense of high resolution can be obtained by using the luminance signal of W having a high resolution and a high luminance and the color signal for each 4×4 block.

### Fourth Embodiment

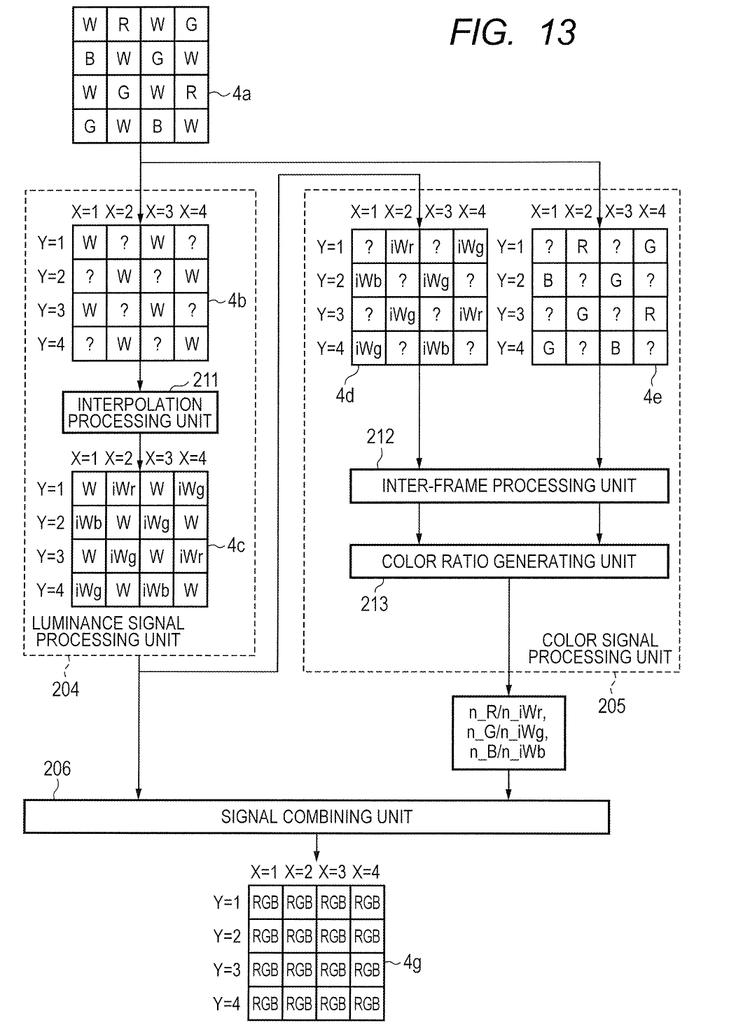

FIG. 13 is a block diagram of a signal processing unit 2 of an imaging apparatus according to a fourth embodiment of the present invention. The imaging apparatus according to this embodiment is described below mainly in terms of points different from those of the first embodiment. In this embodiment, the imaging device 1 includes an RGBW8 array illustrated in FIG. 4C, and the signal processing unit 2 processes a pixel signal 4a of the RGBW8 array. The W pixels of the RGBW8 array are smaller in number than those of RGBW12, and hence the sensitivity is liable to be lowered. Meanwhile, RGB pixels exist around each W pixel, and hence the false color hardly occurs.

As illustrated in FIG. 13, the pixel signal 4a received from the imaging device 1 is separated into a pixel signal 4b of W being a luminance signal and a pixel signal 4e of RGB being a color signal. The luminance signal processing unit 204 obtains a pixel value in each of parts from which RGB pixels have been separated within the pixel signal 4b by the interpolation processing, and generates a pixel signal 4c subjected to the interpolation.

The color signal processing unit 205 generates the color ratio information by using the pixel values of iW subjected to the interpolation and the pixel values of RGB. The inter-frame processing unit 212 subjects each of the pixel values of iW subjected to the interpolation and the pixel values of RGB to the averaging processing using a plurality of frames. The inter-frame processing conducted in this case is the same as that of the first embodiment. Therefore, the color ratio information RGB_ratio is expressed for each pixel in the following manner.

$$RGB\_ratio = [ \begin{matrix}\frac{n\_R}{n\_iWr} & \frac{n\_G}{n\_iWg} & \frac{n\_B}{n\_iWb}\end{matrix} ]$$

The signal combining unit 206 uses a pixel signal 4c of W and iW and the color ratio information RGB_ratio to obtain the value of RGB of each pixel and generate an image signal 4g. In the same manner as in the first embodiment, the pixel value of RGB is expressed by one of the following expressions depending on which of W and iW the pixel is.

RGB=[R_ratio·W G_ratio·W B_ratio·W]

RGB=[R_ratio·iW G_ratio·iW B_ratio·iW]

In this embodiment, through the use of the RGBW8 array, the sensitivity and the resolution of an image became lower than the first embodiment, but the reduction in the false colors in the moving image was enabled depending on the design pattern of an object.

### Fifth Embodiment

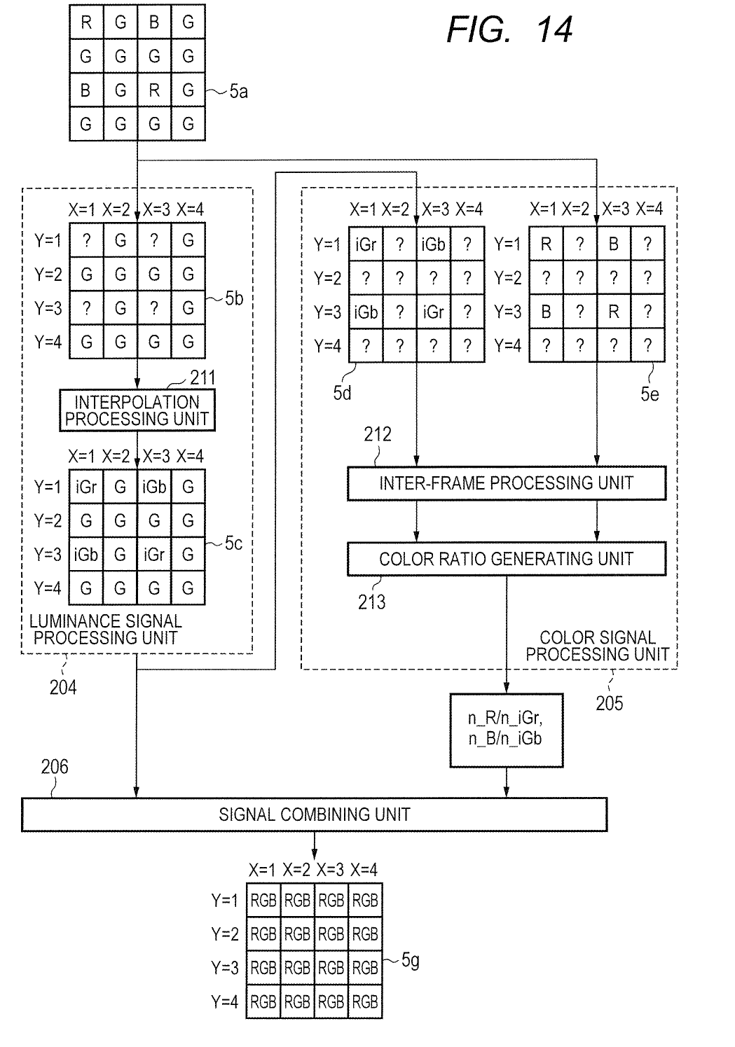

FIG. 14 is a block diagram of a signal processing unit 2 of an imaging apparatus according to a fifth embodiment of the present invention. The imaging apparatus according to this embodiment is described below mainly in terms of points different from those of the first embodiment. The imaging device 1 uses CFs of an RGBG12 array illustrated in FIG. 4D. In the RGBG12 array, the W pixel of RGBW12 is replaced by the G pixel, and hence the sensitivity is liable to be lowered. However, the W pixel exhibits a higher sensitivity than the RGB pixel, and hence, when an image of the object having a high luminance is picked up, the W pixel can be saturated, and the dynamic range can be lowered. In this embodiment, through the use of the CFs of the RGBG12 array, the sensitivity and the saturation of the signal can be balanced. In this example, the G pixel outputs the first pixel signal based on the light having the first wavelength band including the wavelength band corresponding to green. The RB pixel outputs the second pixel signal based on the light having a wavelength band different from the first wavelength band.

The pixel signal 5a is separated into a pixel signal 5b of G and a pixel signal 5e of RB. The luminance signal processing unit 204 conducts interpolation processing for parts in which a pixel value of G does not exist within the pixel signal 5b to generate the pixel values of iG. The color signal processing unit 205 generates the color ratio information by using the interpolated pixel values of iG and the pixel values of RB.

The inter-frame processing unit 212 subjects each of the pixel values of iG subjected to the interpolation and the pixel values of RB to the averaging processing using a plurality of frames. The inter-frame processing conducted in this case is the same as that of the first embodiment. The color ratio generating unit 213 arithmetically operates the color ratio in each pixel, to thereby calculate color ratio information RB_ratio.

$$RB\_ratio = [ \begin{matrix}\frac{R}{iGr} & \frac{B}{iGb}\end{matrix} ]$$

In the same manner as in the first embodiment, on the assumption that the color ratio among the respective colors is constant in a 4×4 area, the signal combining unit 206 uses a pixel signal 5c of G and iG and the color ratio information RB_ratio to obtain the value of RGB for each given pixel. The pixel value of RGB is obtained in the following manner depending on which of G and iG the given pixel is.

RGB=[R_ratio·G G B_ratio·G]

RGB=[R_ratio·iG iG B_ratio·iG]

In a photographed image, the sensitivity and the resolution were lower than in the first embodiment, but through use of RGB pixels, the reduction in the false colors caused when a moving image was being photographed was enabled while the saturation was suppressed. In this manner, the luminance signal is not limited to the signal of the W pixel unlike in the first embodiment, and it suffices that the luminance signal is information of a pixel including a large amount of luminance information (G pixel in this embodiment) in a visual characteristic. It suffices that the color signal is the signal of a pixel including a relatively small amount of luminance information (R pixel and B pixel in this embodiment). In this embodiment, the pixel signal 5a is separated into the pixel signal 5b of G and the pixel signal 5e of RB, but the same effects can be produced also by separating the data including a large amount of luminance information and the data including a small amount of luminance information through an arithmetic operation.

### Sixth Embodiment

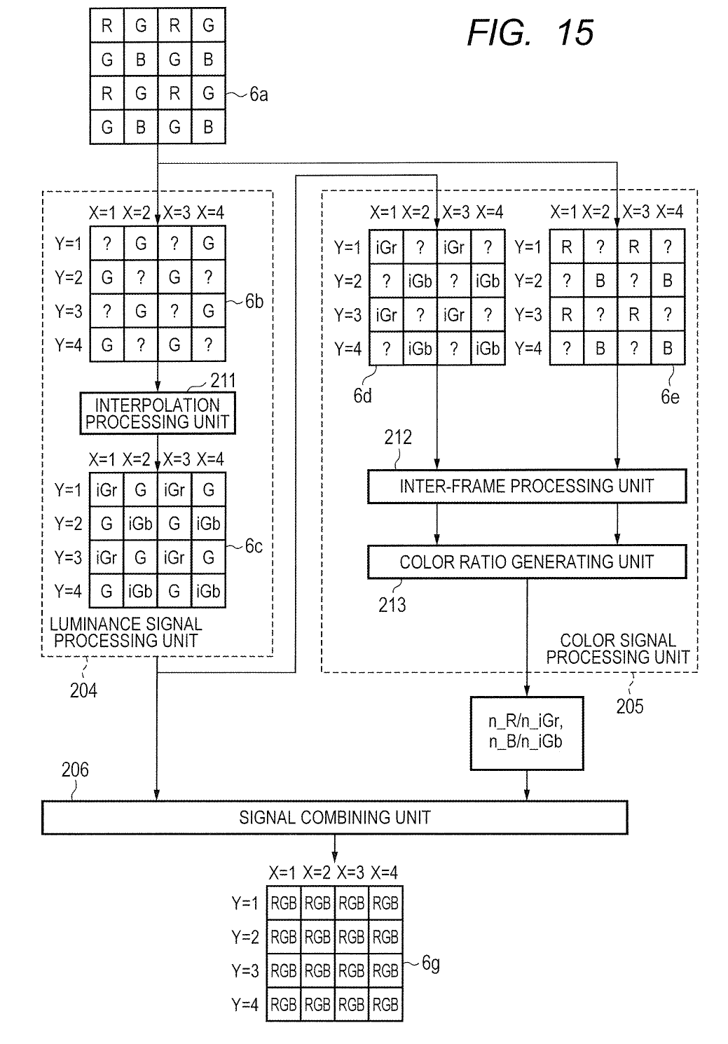

FIG. 15 is a block diagram of a signal processing unit 2 of an imaging apparatus according to a sixth embodiment of the present invention. The imaging apparatus according to this embodiment is described below mainly in terms of points different from those of the first embodiment. In this embodiment, the imaging device 1 uses CFs of the Bayer (RGB) array illustrated in FIG. 4A. The luminance signal processing unit 204 conducts processing with pixel value of G as a luminance signal, and the color signal processing unit 205 conducts processing with the pixel values of RB as color signals. The Bayer array has a lower sensitivity than the CFs using W pixels, and a small number of pixels for the luminance signal, and hence a sense of resolution is inferior. However, the number of pixels used for the color signal is large, and hence the effect of reducing the false colors can be obtained. The numbers of times that the frame processing is conducted for the interpolated luminance signal and the color signal are caused to match each other, which improves the accuracy of calculating the color signal, to thereby be able to further reduce the false colors caused when a moving image is being photographed.

In FIG. 15, a pixel signal 6a of the Bayer (RGB) array is separated into a pixel signal 6b of G and a pixel signal 6e of R and B. The interpolation processing unit 211 conducts interpolation processing for parts from which RB pixels have been separated within the pixel signal 6b to generate the pixel values of iG. The color signal processing unit 205 generates the color ratio information by using the pixel values of iG interpolated by the luminance signal processing unit 204 and the pixel values of RB. The inter-frame processing unit 212 subjects each of the pixel values of iG and the pixel values of RB to the averaging processing using a plurality of frames. The inter-frame processing conducted in this case is the same as that of the first embodiment. The color ratio generating unit 213 arithmetically operates the color ratio in each pixel position, to thereby calculate the color ratio information.

$$RB\_ratio = [ \begin{matrix}\frac{R}{iGr} & \frac{B}{iGb}\end{matrix} ]$$

In the same manner as in the first embodiment, on the assumption that the color ratio among the respective colors is constant in a 4×4 area, the signal combining unit 206 uses a pixel signal 6c of W and the color ratio information RB_ratio to obtain the pixel value of RGB for each given pixel. The pixel value of RGB is obtained by one of the following expressions depending on which of G and iG the given pixel is.

RGB=[R_ratio·G G B_ratio·G]

RGB=[R_ratio·iG iG B_ratio·iG]

In a photographing result obtained in this embodiment, the sensitivity and the resolution were lower than in the first embodiment. However, compared to the moving image of the Bayer array that was not subjected to the inter-frame processing, the effect of reducing the false colors caused when a moving image was being photographed was obtained.

### Seventh Embodiment

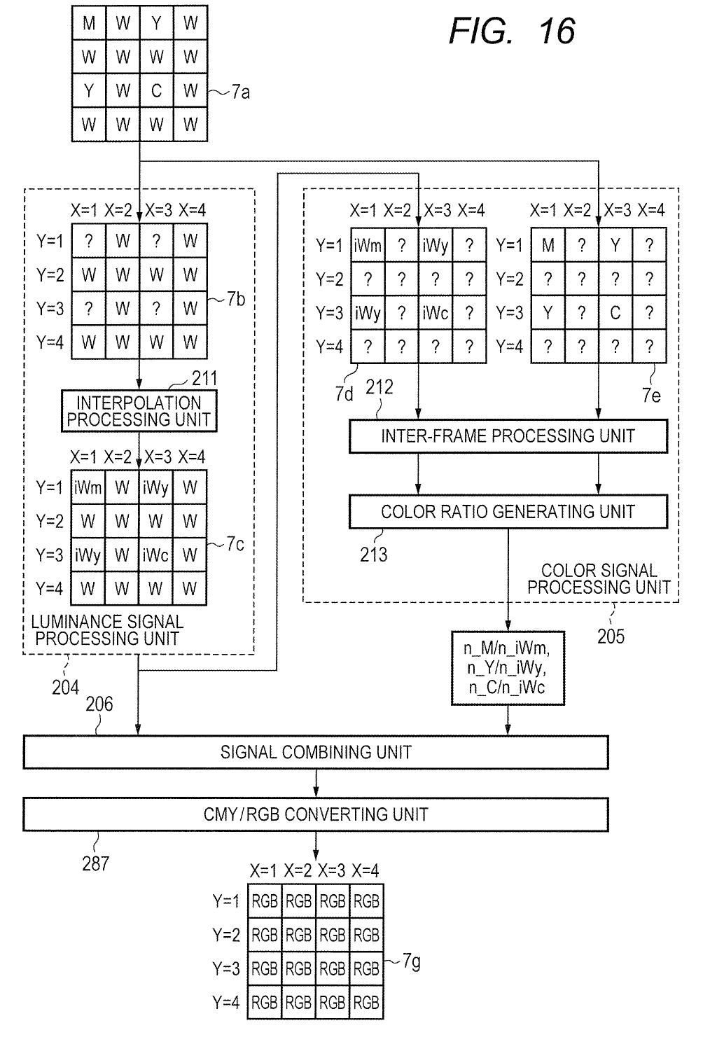

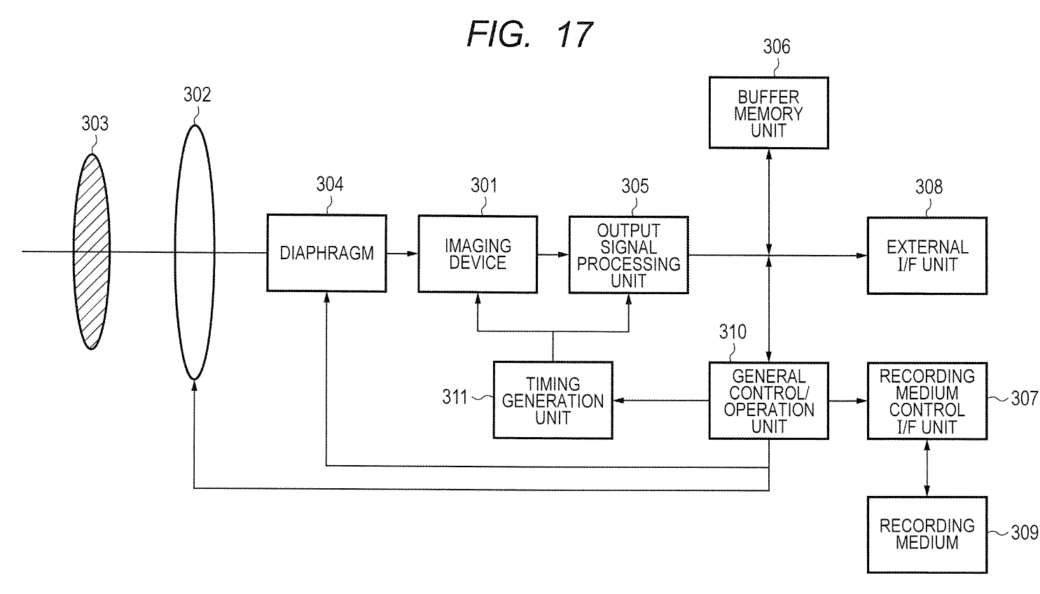

FIG. 16 is a block diagram of a signal processing unit 2 of an imaging apparatus according to a seventh embodiment of the present invention. The imaging apparatus according to this embodiment is described below mainly in terms of points different from those of the first embodiment. The imaging device 1 according to this embodiment uses a CMYW12 array illustrated in FIG. 5B. The CMYW12 array uses the W pixels in addition to the pixels of complementary colors (C, M, and Y) having a high sensitivity, to thereby be able to improve the sensitivity.

In FIG. 16, a pixel signal 7a received from the imaging device 1 is separated into a pixel signal 7b of W and pixel signals 7e of C, M, and Y. The luminance signal processing unit 204 conducts interpolation processing for parts from which the pixels of C, M, and Y have been separated within the pixel signal 7b to generate the pixel values of iW. The color signal processing unit 205 uses the interpolated pixel values of iW and the pixel values of CMY to generate the color ratio information. The inter-frame processing unit 212 subjects each of the pixel values of iW subjected to the interpolation and the pixel values of CMY to the averaging processing using a plurality of frames. The inter-frame processing conducted in this case is the same as that of the first embodiment. Color ratio information CMY ratio in each pixel is expressed by the following expression.

$$CMY\_ratio = [ \begin{matrix}\frac{C}{iWc} & \frac{M}{iWm} & \frac{Y}{iWy}\end{matrix} ]$$

On the assumption that the color ratio among the respective colors is constant in a 4×4 area, the signal combining unit 206 uses a pixel signal 7c of W and the color ratio information CMY ratio to obtain the value of CMY for each given pixel. The pixel value of CMY is obtained by one of the following expressions depending on which of W iW the given pixel is.

CMY=[C_ratio·W M_ratio·W Y_ratio·W]

CMY=[C_ratio·iW M_ratio·iW Y_ratio·iW]

A CMY/RGB converting unit 287 converts the pixel values of CMY output from the signal combining unit 206 into the pixel values of RGB, and outputs an image signal 7g. The imaging apparatus used to conduct the above-mentioned processing was used to conduct evaluation photographing. The sensitivity was higher than in the first embodiment even though color reproducibility was lower partially in an image pattern, and the false color caused when a moving image was being photographed was suppressed. The processing of the signal combining unit 206 may be executed after the processing of the CMY/RGB converting unit 287, or the two pieces of processing may be executed integrally.

### Eighth Embodiment

An image pickup system according to an eighth embodiment of the present invention is described. The imaging apparatus according to the above-mentioned first to seventh embodiments can be applied to various imaging systems. The imaging system is an apparatus configured to acquire an image and a moving image by using the imaging apparatus, and examples thereof include a digital still camera, a digital camcorder, a surveillance camera, and a mobile terminal. FIG. 17 is a block diagram for illustrating a system in which the imaging apparatus according to one of the first to seventh embodiments is applied to a digital still camera employed as an example of the imaging system.

In FIG. 17, the imaging system includes a lens 302 configured to image an optical image of an object on an imaging device 301, a barrier 303 for protection of the lens 302, and a diaphragm 304 for adjustment of an amount of light that has passed through the lens 302. The imaging system includes an output signal processing unit 305 configured to process an output signal output from the imaging device 301.

The output signal processing unit 305 includes a digital signal processing unit, and is further configured to subject the signal output from the imaging device 301 to various kinds of correction and compression as the need arises, and to output the signal. When the signal output from the imaging device 301 is an analog signal, the output signal processing unit 305 may include an analog-to-digital conversion circuit in the previous stage of the digital signal processing unit.

The imaging system includes a buffer memory unit 306, a recording medium control interface (I/F) unit 307, an external interface (I/F) unit 308, a recording medium 309, a general control/operation unit 310, a timing generation unit 311. The buffer memory unit 306 is configured to temporarily store image data received from the output signal processing unit 305. The recording medium control I/F unit 307 is configured to record or read the image data into or from the recording medium 309. The recording medium 309 is formed of, for example, a semiconductor memory, and can be inserted into or removed from the imaging system or can be built into the imaging system. The external I/F unit 308 can communicate to or from an external computer or a network. The general control/operation unit 310 has a function of conducting various kinds of arithmetic operation processing and overall control of the digital still camera. The timing generation unit 311 is configured to output various timing signals to the output signal processing unit 305. A control signal such as a timing signal may be input from the outside instead of from the timing generation unit 311. As described above, the imaging system according to this embodiment can conduct an image pickup operation through application of the imaging device 301 described in the first to seventh embodiments.

### OTHER EMBODIMENTS

While an imaging apparatus in the present invention has been described, the present invention is not limited to the embodiments given above, and the embodiments are not to inhibit suitable modifications and variations that fit the spirit of the present invention. For example, the configurations of the above-mentioned first to eighth embodiments can also be combined. The imaging apparatus does not necessarily include an imaging device, and may be an image processing system such as a computer configured to process a pixel signal output from the imaging device.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-095406, filed May 8, 2015, which is hereby incorporated by reference herein in its entirety.

What is claimed is:

1. An imaging apparatus configured to conduct signal processing for a pixel signal received from an imaging device,
the imaging device comprising:
a first pixel group comprising a plurality of pixels each configured to output a first pixel signal based on light having a first wavelength band comprising at least a wavelength band corresponding to green; and
a second pixel group comprising a plurality of pixels each configured to output a second pixel signal based on one of light having a wavelength band narrower than the first wavelength band and light having a wavelength band different from the first wavelength band,
the imaging apparatus comprising:
a first signal processing unit configured to generate first data on a plurality of frames by executing processing for generating the first data by using first pixel signals in one frame, which have been output from the first pixel group, for the first pixel signal in each frame, the first data being obtained by interpolating the pixel signal corresponding to the first wavelength band in the second pixel group;
a second signal processing unit configured to generate second data on a plurality of frames by using second pixel signals in the plurality of frames, which have been output from the second pixel group; and
a signal combining unit configured to generate an image by combining the first data on the plurality of frames and the second data on the plurality of frames.

2. An imaging apparatus according to claim 1, wherein:
the second signal processing unit is further configured to generate the second data on a plurality of frames by using the second pixel signal in the each frame used by the first signal processing unit to generate the first data on the plurality of frames; and
the signal combining unit is further configured to generate the image by combining the first data on the plurality of frames and the second data on the plurality of frames.

3. An imaging apparatus according to claim 1, wherein the second data comprises one of a ratio between the first data and the second pixel signal in each of the plurality of pixels of the second pixel group and a ratio between an average of a plurality of the first data and the second pixel signal in each of the plurality of pixels of the second pixel group.

4. An imaging apparatus according to claim 1, wherein the second data comprises a difference between an average of a plurality of the first data and the second pixel signal in each of the plurality of pixels of the second pixel group.

5. An imaging apparatus according to claim 1, wherein the first data on the plurality of frames is obtained by using a non-recursive filter.

6. An imaging apparatus according to claim 1, wherein the first data on the plurality of frames is obtained by using a recursive filter.

7. An imaging apparatus according to claim 1, wherein the first data on the plurality of frames is obtained by using a moving average.

8. An imaging apparatus according to claim 1, wherein the signal combining unit is further configured to conduct demosaicing processing for generating a pixel signal obtained by expressing a signal of each pixel by respective values of R, G, and B.

9. An imaging apparatus according to claim 1, wherein the first pixel group has a higher degree of contribution to a luminance than the second pixel group.

10. An imaging apparatus according to claim 1, wherein the second pixel group comprises pixels having mutually different wavelength bands of light on which the second pixel signal is based.

11. An imaging apparatus according to claim 1, wherein the plurality of pixels of the first pixel group each comprise a white pixel.

12. An imaging apparatus according to claim 1, wherein the plurality of pixels of the second pixel group each comprise any one of an R pixel, a G pixel, and a B pixel.

13. An imaging apparatus according to claim 1, wherein the plurality of pixels of the second pixel group each comprise any one of a C pixel, an M pixel, and a Y pixel.

14. An imaging apparatus according to claim 1, wherein a number of pixels of the first pixel group is larger than a number of pixels of the second pixel group.

15. An imaging apparatus according to claim 1, wherein a number of pixels of the first pixel group is three or more times larger than a number of pixels of the second pixel group.

16. An imaging system, comprising:
an imaging apparatus; and
an output signal processing unit configured to process a signal output from the imaging apparatus,
the imaging apparatus being configured to conduct signal processing for a pixel signal received from an imaging device,
the imaging device comprising:
a first pixel group comprising a plurality of pixels each configured to output a first pixel signal based on light having a first wavelength band comprising at least a wavelength band corresponding to green; and
a second pixel group comprising a plurality of pixels each configured to output a second pixel signal based on one of light having a wavelength band narrower than the first wavelength band and light having a wavelength band different from the first wavelength band,
the imaging apparatus comprising:
a first signal processing unit configured to generate first data on a plurality of frames by executing processing for generating the first data by using first pixel signals in one frame, which have been output from the first pixel group, for the first pixel signal in each frame, the first data being obtained by interpolating the pixel signal corresponding to the first wavelength band in the second pixel group;
a second signal processing unit configured to generate second data on a plurality of frames by using second pixel signals in the plurality of frames, which have been output from the second pixel group; and
a signal combining unit configured to generate an image by combining the first data on the plurality of frames and the second data on the plurality of frames.

17. A signal processing method for conducting signal processing for a pixel signal received from an imaging device,
the imaging device comprising:
a first pixel group comprising a plurality of pixels each configured to output a first pixel signal based on light having a first wavelength band comprising at least a wavelength band corresponding to green; and
a second pixel group comprising a plurality of pixels each configured to output a second pixel signal based on one of light having a wavelength band narrower than the first wavelength band and light having a wavelength band different from the first wavelength band,
the signal processing method comprising:
generating first data on a plurality of frames by executing processing for generating the first data by using first pixel signals in one frame, which have been output from the first pixel group, for the first pixel signal in each frame, the first data being obtained by interpolating the pixel signal corresponding to the first wavelength band in the second pixel group;
generating second data on a plurality of frames by using second pixel signals in a plurality of frames, which have been output from the second pixel group; and
generating an image by combining the first data on the plurality of frames and the second data on the plurality of frames.
